(19) United States
(12) Patent Application Publication
(10) Pub. No.: US 2014/0312164 A1
(43) Pub. Date: Oct. 23, 2014

(54) PORTABLE UNMANNED AIRCRAFT FOR NEAR-INSTANT AERIAL SURVEILLANCE

(71) Applicants: JOSHUA M. GIBSON, Morristown, TN (US); SAGAR JASU PANARA, Morristown, TN (US)

(72) Inventors: JOSHUA M. GIBSON, Morristown, TN (US); SAGAR JASU PANARA, Morristown, TN (US)

(21) Appl. No.: 13/745,322

(22) Filed: Jan. 18, 2013

Related U.S. Application Data
(60) Provisional application No. 61/587,738, filed on Jan. 18, 2012.

(51) Int. Cl. B64C 39/02; B64C 27/00; B64D 47/08

(52) U.S. Cl. CPC B64C 39/02; B64D 47/08; B64C 27/00; B64C 2201/00
USPC 244/13; 244/4 R; 244/17.11

(57) ABSTRACT

A portable unmanned aerial vehicle or aircraft, capable of being easily carried by a single individual by means of a mounting device, which can be fastened on a belt or strap. The aerial vehicle comprises a wing attached at one end to a fan or turbine assembly. The fan or turbine assembly may be electrically driven, with power supplied by one or more batteries. In flight, the fan or turbine assembly causes the aerial vehicle to rotate around its center-of-mass (COM), with lift provided by the wing as it rotates. A camera is located on the aircraft at or near the COM.

This application claims benefit of and priority to U.S. Provisional Application No. 61/587,738, filed Jan. 18, 2012, by Joshua M. Gibson, and is entitled to that filing date for priority. The specification, figures and complete disclosure of U.S. Provisional Application No. 61/587,738 are incorporated herein by specific reference for all purposes.

### FIELD OF INVENTION

This invention relates to a portable unmanned aircraft. More particularly, this invention relates to a portable unmanned aircraft that can be carried by a single individual on a utility belt or other form of mount.

### BACKGROUND OF THE INVENTION

Unmanned aerial vehicles have proven to be extremely well-suited for surveillance missions, as compared to manned aircraft. Currently, when a need for aerial surveillance is present, a manned helicopter or similar aircraft must be called in. The aircraft must be started and flown to the scene from a typically remote location or port. This delay often makes the aerial surveillance moot, as it takes too long for the craft to get into place and the information to become available. In addition, manned aircraft usually are very expensive to operate and maintain.

However, unmanned aerial vehicles known in the art are difficult to transport, often require being carried on special vehicles or by multiple individuals, or do not provide for easy retrieval and review of images.

### SUMMARY OF INVENTION

In various exemplary embodiments, the present invention comprises a portable unmanned aerial vehicle or aircraft, capable of being easily carried by a single individual on a mounting apparatus attached to a belt or strap, who can then utilize it when and where needed with minimal delay and with minimal knowledge required to operate the aircraft. The aircraft does not need assembly, and does not need to be removed from a carrying case or similar container.

In one embodiment, the aerial vehicle comprises a wing attached at one end to a fan or turbine assembly. The fan or turbine assembly may be electrically driven, with power supplied by one or more batteries. The batteries may be rechargeable. In flight, the fan or turbine assembly causes the aerial vehicle to rotate around its center-of-mass (COM) in the direction indicated by the arrows, with lift provided by the wing as it rotates.

The center section proximate the COM comprises a camera assembly (typically placed on the center of rotation on the underside of the center section so as to take still pictures or video during flight), and the primary inertial navigation, stability and flight control systems. The center section further comprises a processor or microprocessor and a wireless communication device. The latter can send and receive signals wirelessly to a control unit (which may be in the belt mount, an application in a smart phone, tablet computer or similar computing device, a vehicle, or some other remote location), and also can send and receive information from the camera assembly.

The camera or imaging device may provide normal visible spectrum imaging, infrared spectrum imaging, hyperspectral imaging, or other forms of imaging.

In several embodiments, a hiller extends from the front of the wing to provide directional control. An electromechanical servo mechanism may be used to rotate or move the hiller to the desired attitude or angle. The hiller may be fixed in place, or may be removable. Alternatively, shape memory alloys may be used to replace the hiller, and thus eliminate a protruding element from the aircraft.

The belt mount apparatus is designed to be held by a belt or strap, and comprises two curved holding arms adapted to hold the fan or turbine assembly securely. A locking mechanism may be used to hold the fan or turbine assembly in place when mounted. Other forms of mounting the aircraft on an individual can be used, such as a thigh or shoulder strap mount. These mounts allow the airframe to be mounted on the user such that access is not restricted, and the device does not encumber the user.

In another embodiment, the aircraft can be mounted to a vehicle, such as a car, truck or van. It may be mounted in the trunk, back, roof or other convenient location in the vehicle. This configuration allows for more advanced imaging option and higher loitering times, as the weight of the device will not be limited to what can easily be carried by an individual user. In addition, the aircraft can be continuously charged while mounted on a vehicle, using power generated by the vehicle.

In operation, the aircraft is essentially autonomous, and is capable of sensing a variety of parameters, including but not limited to: altitude, distance from the user (a GPS system can be used in the aircraft and the mounting apparatus), rotational speed, and other input deemed necessary by the stability augmentation system or other operational system. The aircraft may be controlled by the user through means of a control unit in the mount, a separate control unit, or an application on a smart phone, tablet computer, or other computing device. The aircraft also may be controlled from a remote location.

In one embodiment, the user wears a secondary inertial navigation device, which is used to provide the aircraft with information about where it is flying in space alongside an onboard inertial reference system. Reliance on a GPS signal can be a limiting factor for usefulness of the aircraft, and a secondary inertial navigation system can replace the GPS found in most modern INS-based autopilot system. Utilizing the secondary INS can substantially reduce the error in determining location.

In an exemplary embodiment, in order to ensure that angular position is known to a high degree of precision, the secondary INS informs the primary INS each time the wing tip passes the location of the secondary INS. In this manner, each rotation of the wing through space can be tracked, and this can be used to trigger the camera or imaging device. The secondary INS also may provide a means for the aircraft to track the user during routine use (and to locate the user when directed to return to the user, and thereby act as a homing device). The secondary INS may be contained in the mounting apparatus, although it also may be separate from the mounting apparatus. In one embodiment, the mounting apparatus comprises a homing button, which the user can press to cause the aircraft to automatically return to the user.

In several embodiments, the camera or imaging device is located at the center of mass (although it may be located elsewhere on the aircraft in different embodiments). When located at the center of mass, the camera is located at the center of rotation, and when the aircraft is in operation, may process an image each time the wing passes through a defined angular location. A computer program flags each image with a marker that corresponds to the angle and time the image was acquired. The program can then line up each image with sequential images to produce a moving image.

In some situations where the aircraft is used, the user may not have the ability to monitor safely or effectively the imaging data being gathered. The device can then transfer the data via wireless connection (such as a cellular network data connection) to a remote station or individual (separate from the primary user who initially carried the aircraft to the location) to monitor the images and inform the primary user of what is being observed. A computer program operating at the remote view site can be used to control the aircraft and its options, and to process and present the image data for review and analysis. The processing may involve a computer-implemented algorithm to align the images as described above.

### BRIEF DESCRIPTION OF THE DRAWINGS

FIG. 1 shows a view of a unmanned aircraft in accordance with an embodiment of the present invention.

FIGS. 2-6 show other views of the unmanned aircraft of FIG. 1, along with a mounting apparatus.

FIG. 7 shows an exploded view of the unmanned aircraft of FIG. 1, along with a mounting apparatus

FIGS. 8-10 shows views of a belt mount for the unmanned aircraft of FIG. 1.

FIG. 11 shows an example of a control screen.

### DETAILED DESCRIPTION OF EXEMPLARY EMBODIMENTS

In various exemplary embodiments, the present invention comprises a portable unmanned aerial vehicle or aircraft, capable of being easily carried by a single individual who can then utilize it when and where needed with minimal delay and with minimal knowledge required to operate the aircraft. The aircraft does not need assembly, and does not need to be removed from a carrying case or similar container.

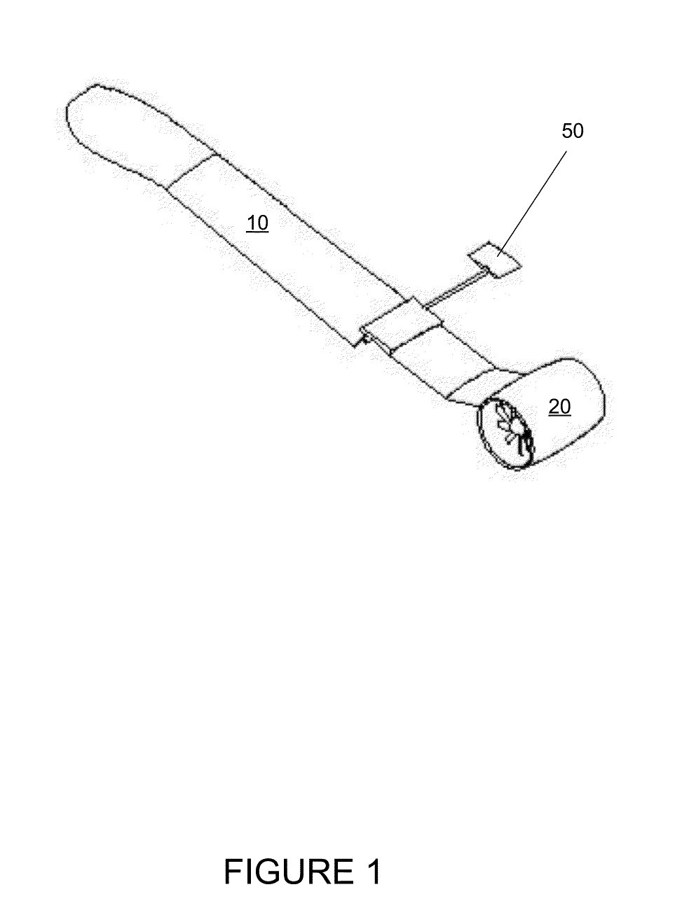

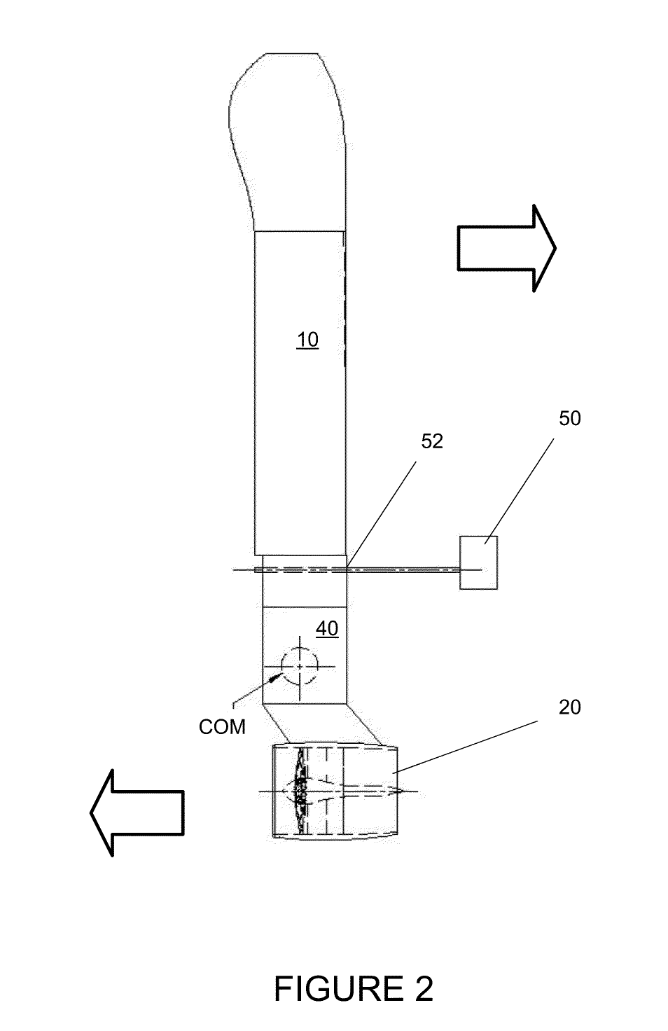

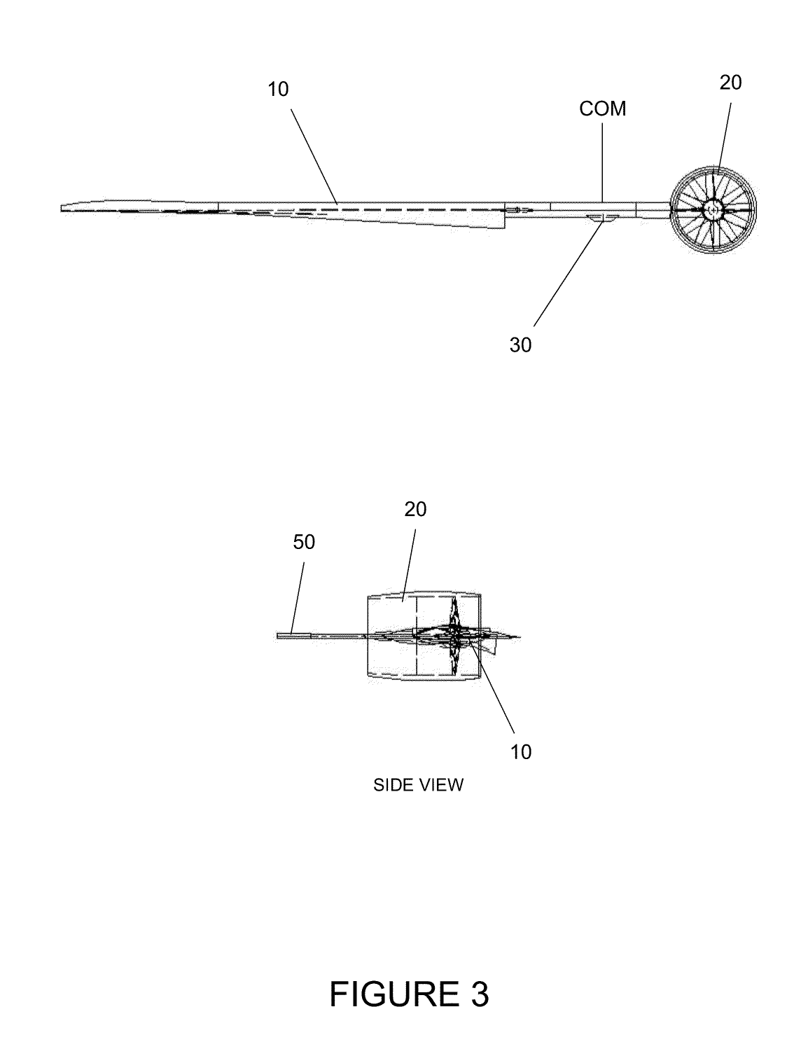

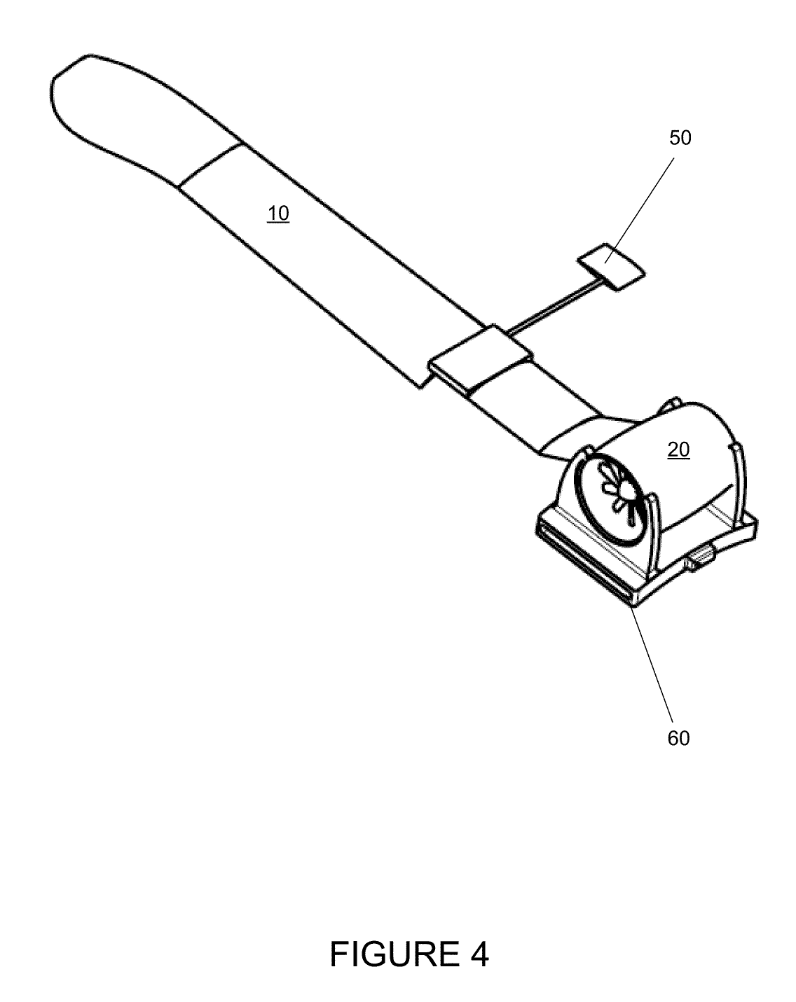

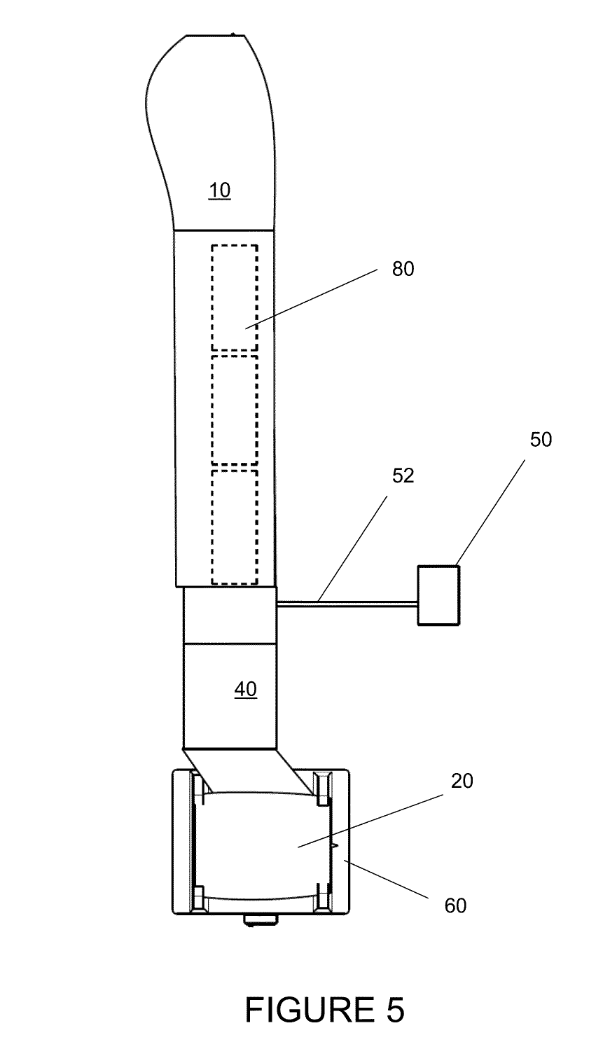

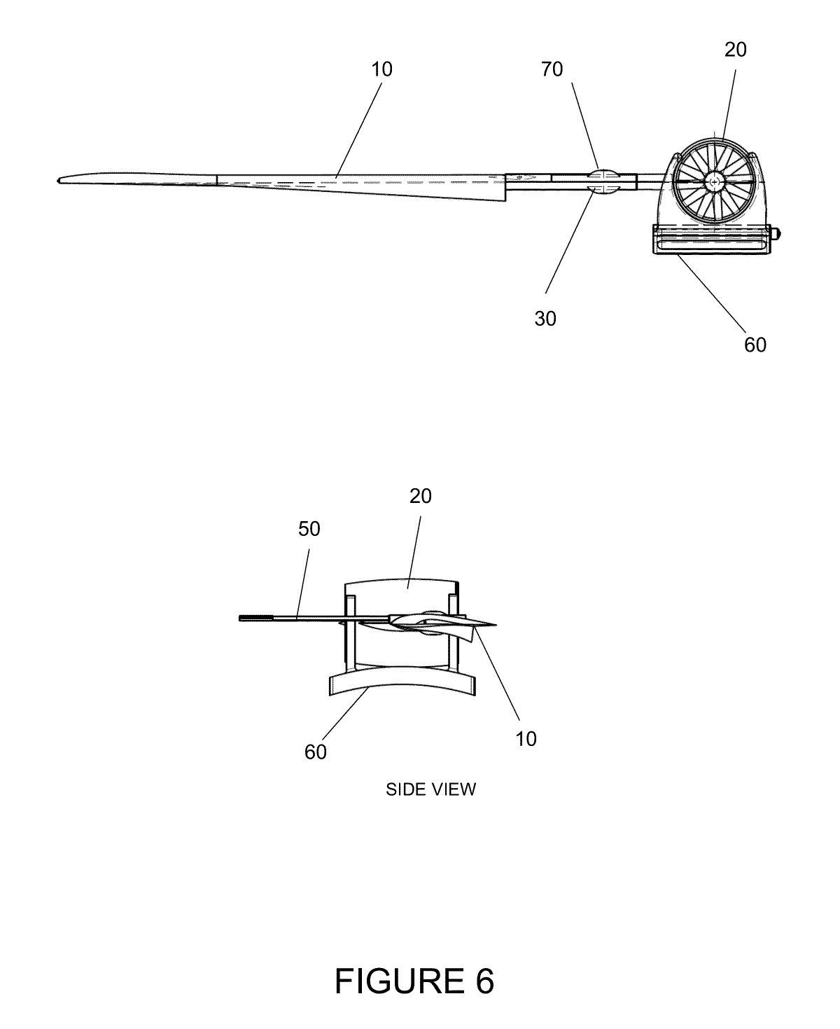

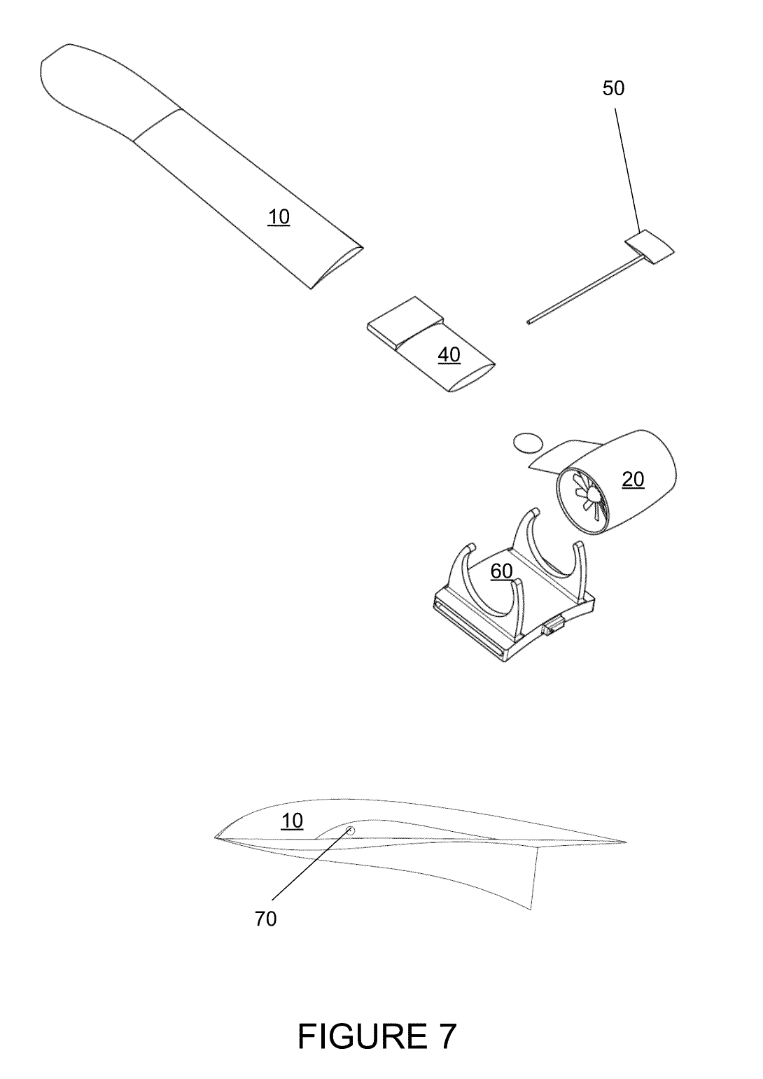

FIGS. 1-10 show an exemplary embodiment of such an unmanned aerial vehicle using a mono-wing samara plan form, along with a mounting apparatus. The aircraft is similar in appearance to the Acer Saccharrum seed, which utilizes a naturally induced stability to render a slow glide as it falls from the tree. Examples of unmanned aerial vehicles based upon similar principles include the “Active Maple Seed Flyer” disclosed in U.S. Pat. No. 7,766,274, and the “Controllable Miniature Mono-Wing Aircraft” disclosed in U.S. Pub. No. 2011/0062278 (both of which are incorporated herein by specific reference for all purposes).

The aerial vehicle in this configuration comprises a wing or flying surface 10 attached at one end to a fan or turbine assembly 20. The fan or turbine assembly may be electrically driven, with power supplied by one or more primary flight battery or batteries 80. The batteries may be rechargeable. In one embodiment, a secondary battery pack or power supply located in the mounting apparatus may be used to recharge the primary flight battery or batteries. Alternatively, batteries may be recharged via a vehicle-based recharging system. The primary flight battery or batteries may be easily removed and replaced from the aircraft. Alternatively, the battery or batteries may be contained in a portion of the aircraft (such as the wing or flying surface) that is removable, so that removing and replacing that component will also result in battery replacement. Battery replacement allows for multiple flights beyond single battery capacity.

In flight, the fan or turbine assembly causes the aerial vehicle to rotate around its center-of-mass (COM) in the direction indicated by the arrows, with lift provided by the wing as it rotates. The center section proximate the COM comprises a camera assembly 30 (typically placed on the center of rotation on the underside of the center section so as to take still pictures or video during flight), and the primary inertial navigation, stability and flight control systems 40. The center section further comprises a processor or microprocessor and a wireless communication device. The latter can send and receive signals wirelessly to a control unit (which may be in the belt mount 60, an application in a smart phone, tablet computer or similar computing device, a vehicle, or some other remote location), and also can send and receive information from the camera assembly.

The camera or imaging device may provide normal visible spectrum imaging, infrared spectrum imaging, hyperspectral imaging, or other forms of imaging.

In several embodiments, a hiller 50 extends from the front of the wing to provide directional control. An electromechanical servo mechanism 52 may be used to rotate or move the hiller to the desired attitude or angle 50. The hiller may be fixed in place, or may be removable. Alternatively, shape memory alloys may be used to replace the hiller, and thus eliminate a protruding element from the aircraft.

The belt mount apparatus 60 is designed to be held by a belt or strap (which is inserted into a slot or holes 66 on the mount), and comprises two curved holding arms 62 adapted to hold the fan or turbine assembly securely. A latch or locking mechanism may be used to hold the fan or turbine assembly in place when mounted. When used as a belt mount, the wing or flying surface extends downward along the user's legs.

While the embodiment shown is a belt mount apparatus suitable for mounting on a utility or similar belt, other forms of mounting the aircraft on an individual can be used, such as a thigh or shoulder strap mount. These mounts allow the airframe to be mounted on the user such that access is not restricted, and the device does not encumber the user.

In another embodiment, the aircraft can be mounted to a vehicle, such as a car, truck or van. It may be mounted in the trunk, back, roof or other convenient location in the vehicle. This configuration allows for more advanced imaging option and unlimited loitering times, as the weight of the device will not be limited to what can easily be carried by an individual user. In addition, the aircraft can be continuously charged while mounted on a vehicle, using power generated by the vehicle.

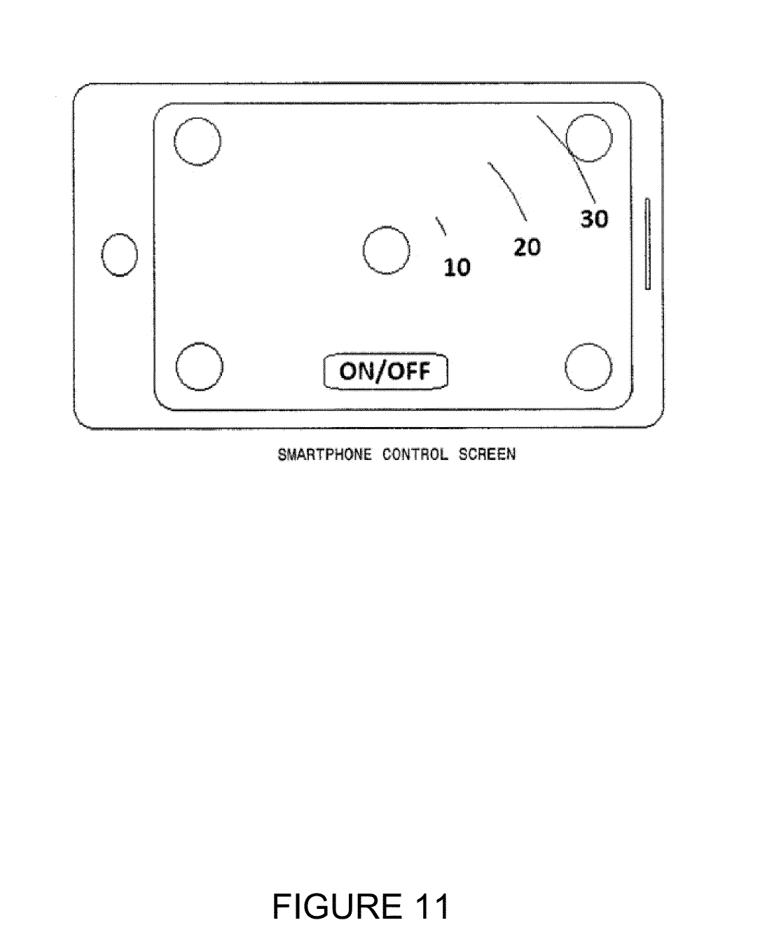

In operation, the aircraft is essentially autonomous, and is capable of sensing a variety of parameters, including but not limited to: altitude, distance from the user (a GPS system can be used in the aircraft and the mounting apparatus), rotational speed, and other input deemed necessary by the stability augmentation system or other operational system. The aircraft may be controlled by the user through means of a control unit in the mount, a separate control unit, or an application on a smart phone (as shown in FIG. 11), tablet computer, or other computing device. The aircraft also may be controlled from a remote location.

In yet another embodiment, the aircraft is able to sense and avoid collision with another object in the flight environment through one or more sound or light-based reflection sensors 70 mounted span-wise on the front, top and/or bottom of the wing or lifting surface. As the wing or lifting surface 10 is rotating during flight, this enables to the sensors 70 to achieve a 360-degree view of the surroundings.

In one embodiment, the user wears a secondary inertial navigation device 68, which is used to provide the aircraft with information about where it is flying in space alongside an onboard inertial reference system. Reliance on a GPS signal can be a limiting factor for usefulness of the aircraft, and a secondary inertial navigation system (INS) can replace the GPS found in most modern INS-based autopilot system. Utilizing the secondary INS can substantially reduce the error in determining location. In one embodiment, the secondary INS comprises a triple-axis accelerometer, triple-axis magnetometer, and a triple-axis gyrometer.

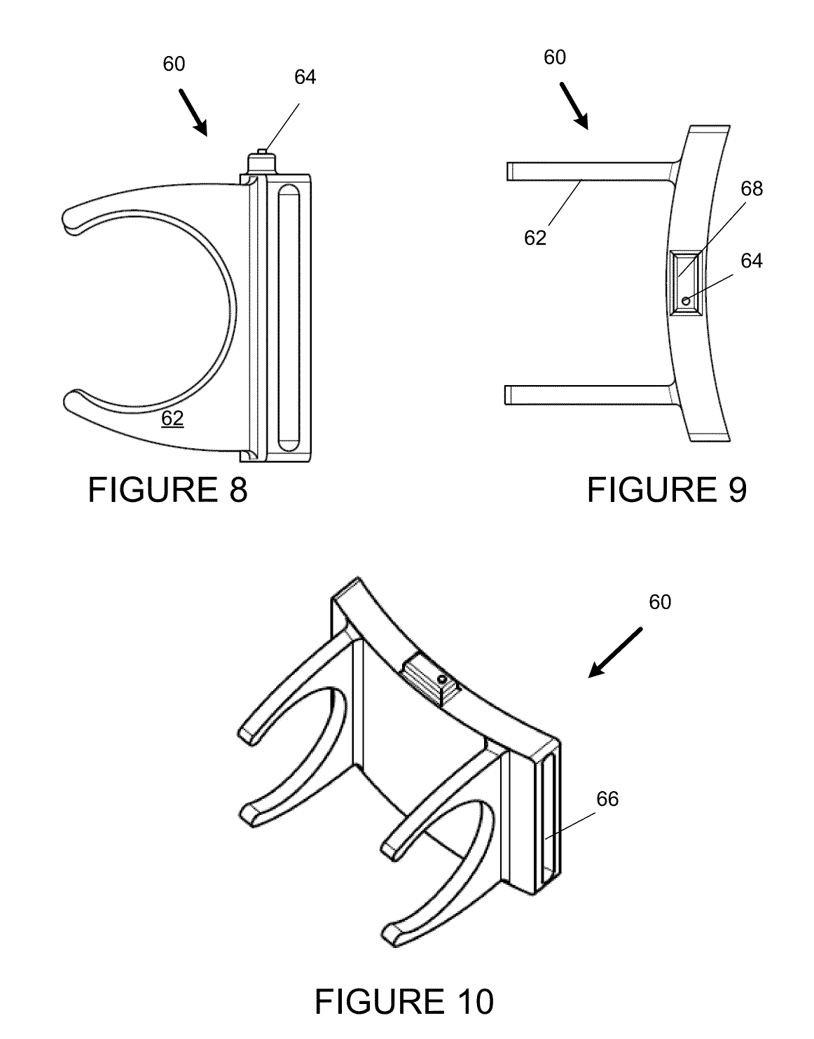

In an exemplary embodiment, in order to ensure that angular position is known to a high degree of precision, the secondary INS informs the primary INS each time the wing tip passes the location of the secondary INS. In this manner, each rotation of the wing through space can be tracked, and this can be used to trigger the camera or imaging device. The secondary INS also may provide a means for the aircraft to track the user during routine use (and to locate the user when directed to return to the user, and thereby act as a homing device). The secondary INS 68 may be contained in the mounting apparatus 60, as seen in FIGS. 8-10, although it also may be separate from the mounting apparatus. In one embodiment, the mounting apparatus comprises a homing button 66, which the user can press to cause the aircraft to automatically return to the user.

In several embodiments, the camera or imaging device 30 is located at the center of mass (although it may be located elsewhere on the aircraft in different embodiments). When located at the center of mass, the camera is located at the center of rotation, and when the aircraft is in operation, may process an image each time the wing passes through a defined angular location. A computer program flags each image with a marker that corresponds to the angle and time the image was acquired. The program can then line up each image with sequential images to produce a moving image.

In some situations where the aircraft is used, the user may not have the ability to monitor safely or effectively the imaging data being gathered. The device can then transfer the data via wireless connection in the center section 40 (such as a cellular network data connection) to a remote station or individual (separate from the primary user who initially carried the aircraft to the location) to monitor the images and inform the primary user of the nature or the images or what is being observed. A computer program operating at the remote view site can be used to control the aircraft and its options, and to process and present the image data for review and analysis. The processing may involve a computer-implemented algorithm to align the images as described above.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments, or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus, comprising:
an unmanned aircraft; and
a mounting device, wherein the mounting device is adapted to enable the unmanned aircraft to be mounted and carried on a single individual.

2. The apparatus of claim 1, wherein the mounting device is mounted on a belt.

3. The apparatus of claim 1, wherein the mounting device is mounted on a strap.

4. The apparatus of claim 1, wherein the unmanned aircraft comprises a mono-wing.

5. The apparatus of claim 1, wherein the unmanned aircraft comprises at least one wing and at least one turbine or ducted fan propulsion system, and possesses a center of mass disposed between the at least one wing and at least one turbine or ducted fan propulsion system, wherein the unmanned aircraft rotates around the center of mass when in flight.

6. The apparatus of claim 5, further comprising a camera or imaging device located at the center of mass.

7. The apparatus of claim 6, further comprising a primary inertial navigation system located in the unmanned aircraft near the center of mass.

8. The apparatus of claim 7, further comprising a hiller extending from one side of the wing.

9. The apparatus of claim 8, wherein the hiller is disposed in the plane of rotation of the unmanned aircraft.

10. The apparatus of claim 7, further comprising a second inertial navigation system located in the mounting device.

11. The apparatus of claim 7, further comprising a wireless communication device located in the unmanned aircraft near the center of mass.

12. The apparatus of claim 7, wherein the camera or imaging device is positioned to take images below the aircraft when in flight.

13. The apparatus of claim 12, wherein the camera or imaging device captures an image each time the wing passes through a defined angular location with respect to the center of mass or center of rotation.

14. The apparatus of claim 13, wherein the image data is sent to a remote computing device, wherein the remote computing device aligns image data captured sequentially based upon the angular location.

15. The apparatus of claim 5, wherein the aircraft is powered by one or more batteries.

16. The apparatus of claim 5, wherein the wing is detachable.

17. The apparatus of claim 16, wherein the wing holds one or more batteries for powering the aircraft.

18. The apparatus of claim 5, further comprising a sound or light-based sensor on the front edge of the wing for detecting objects in the area of the aircraft.
